(19) United States
(12) Patent Application Publication
(10) Pub. No.: US 2026/0356695 A1
(43) Pub. Date: Nov. 12, 2026

(54) MULTI-STAGE WELDLESS FILTRATION VOLUMES FOR WATER TREATMENT

(71) Applicant: ATEC Water Systems, LLC, Los Angeles, CA (US)

(72) Inventor: Lee Odell, Vancouver, WA (US)

(21) Appl. No.: 19/205,911

(22) Filed: May 12, 2025

(51) Int. Cl. C02F 1/00; B01D 39/20

(52) U.S. Cl. CPC C02F 1/001; B01D 39/2068; C02F 2201/004; C02F 2201/005; C02F 2209/03; C02F 2301/08

(57) ABSTRACT

A multi-stage water filter module including a seamless or low-weld cylindrical pipe segment oriented vertically, an inlet, a filter bed of selected media disposed above a ceramic membrane affixed near an outlet thereof, and paired multi-position valves enabling forward filtration, reverse backwash, forward wash, and isolation for chemical restoration/oxidative cleaning.

### TECHNICAL FIELD

Embodiments described herein relate to water filtration systems and, in particular, to weldless or low-weld filter volumes and systems and methods for operation and maintenance thereof.

### BACKGROUND

Conventional filter tanks used in water treatment are often costly to produce and install, requiring significant skilled welding to ensure durable water tightness. After installation, such filter tanks and supporting systems and plumbing are often mechanically complicated and costly to maintain, especially for high volume systems. Specifically, conventional systems require up to four dedicated valves (and associated plumbing) for each tank, each valve requiring at least one dedicated actuator conductively coupled to at least one respective programmable logic units (“PLUS”) or other controller. Each valve must be actuated in a specific order to begin maintenance operations for one or more tanks. Unordered or incorrect valve operation can result in significant system damage, chemical spills, supply or output fouling, or other consequences. Further, many regular maintenance operations expressly require separate clean water sources and additional circulation equipment, including high flowrate pumps.

More broadly, conventional high-volume water filtration systems are associated with significant up-front and ongoing cost. Each weld of each tank represents a potential future failure point, each valve introduces a potential leak path, each actuator introduces a potential mechanical and control failure point, pumps require periodic maintenance and may consume significant power during operation, operator or other control errors can delay or protract maintenance operations, and so on all of which may result in decreased production volume over an extended period of time.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified schematic control diagram of an example monolithic multi-stage filter module set, as described herein.

FIG. 2 depicts a simplified process flow diagram of an example set of monolithic multi-stage filters, as described herein.

FIGS. 3A-3D depicts a simplified flow schematic of a maintenance operation as described herein.

FIG. 4 depicts an example monolithic and/or seamless multi-stage filter as described herein.

FIG. 5 depicts an example array of monolithic multi-stage filters as described herein.

FIG. 6 depicts an example water processing system including multiple arrays of monolithic multi-stage filters.

FIG. 7 depicts a cross-section of a filter-retaining endcap of a multi-stage filter as described herein.

FIG. 8 depicts another cross-section of a filter-retaining endcap of a multi-stage filter as described herein.

FIG. 9 depicts another cross-section of a filter-retaining endcap of a multi-stage filter as described herein.

FIG. 10 is a flowchart depicting example operations of a method of operating a multi-stage filter as described herein.

FIG. 11 is a flowchart depicting example operations of a method of maintaining a multi-stage filter as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to seamless multi-stage filter volumes for water treatment of a water source (e.g., surface water, ground water, industrial output, and the like), and arrays or sets of such filter volumes.

Further embodiments relate to systems and methods for automatically backwashing one or more multi-stage filter volumes of an array of filter volumes by leveraging head pressure of the water source itself.

Still further embodiments relate to systems and methods for automatic oxidative cleaning and/or chemical restoration of one or more filter media disposed within a filter volume as described herein. In many examples, backwashing may be performed automatically at a first interval and oxidative cleaning/chemical restoration can be performed (and/or prepared for) automatically at a second interval that is longer than the first interval. In other examples, backwashing may be performed in respect of a given filter volume automatically in response to satisfying a first differential pressure threshold (e.g., head pressure drop across the filter exceeds a threshold). In these embodiments, automatic oxidative cleaning/chemical restoration may be performed (and/or prepared for) in response to determining, after backwashing, that differential pressure satisfies a second differential pressure threshold.

Generally and broadly, embodiments described herein relate to multimedia or single media reaction volumes (and/or filtration volumes) formed from a seamless length of pipe oriented vertically, with an “inlet” positioned over an “outlet” of the pipe segment. In another non-limiting phrasing, water to be filtered is received at an upper opening of the length of pipe and filtered water is provided as output from a lower opening of the length of pipe.

A length of pipe as described herein can be formed from any number of suitable materials including metals, alloys, plastics, acrylics, polymers, or layered combinations thereof. For example, in some embodiments, an inner portion of a pipe segment may be formed from plastic or a polymer material, while an outer portion of the same pipe segment is formed from metal. Many configurations and constructions are possible. For simplicity of description, the embodiments that follow reference a length of pipe formed from metal, but it may be appreciated that this is merely one example and that some embodiments may be implemented with different materials or combinations of materials.

For uniform pressure distribution and structural integrity, many embodiments described herein reference pipe segments with a circular lateral cross section (e.g., cylindrical pipe), but this is not required. For simplicity of description, circular cross-section pipe segments are referenced herein, but it may be appreciated that this is merely one example and that in some embodiments, pipe segments with noncircular cross sections may be used (e.g., square, rectangular, hexagonal, octagonal, oval, elliptical, or the like).

A segment of pipe (which may be formed from metal, plastic, or another suitable material) as described herein may be defined at least in part by an outer diameter (“OD”), an inner diameter (“ID”), and a length (or height). As may be appreciated, the length, OD, and ID of a pipe may collectively define, at least in part, a pressure capacity of the pipe segment and a volumetric capacity of the pipe segment. Herein, an internal volume of a pipe segment may be referred to as the “filtration volume” of that pipe segment.

A pipe segment can be removably or permanently coupled to one or more headers or endcaps to facilitate plumbing to other systems and encapsulation of the filtration volume defined thereby. For example, in some cases, an upper portion of the pipe can be threaded and engaged with corresponding threads of an input header or input valve. In other embodiments, the upper portion of the pipe can be welded to an input header or input valve. In some embodiments other fastening techniques can be used, which may vary by material selected for the pipe segment, including solvent welding, adhesive, metal welding, push-fit connections, bolts or other fasteners, threaded sections, or the like. In some embodiments, a combination of fasters or coupling mechanisms may be used,. For example, a threaded engagement between the upper portion of a pipe segment and an input header can be additionally welded.

Within a filtration volume of a pipe segment as described herein may be disposed one or more filter media configured to arrest, precipitate, adsorb, or otherwise remove one or more contaminants from water received at the inlet of the pipe segment. Example contaminants include, but are not limited to: chlorine; chloramine; heavy and/or toxic metals (e.g., mercury, lead, arsenic); microbes; viruses; nitrates; nitrites; perfluoroalkyl and polyfluoroalkyl substances; volatile compounds; iron; manganese; sediments; industrial waste; copper; chromium (III and/or VI); and the like. For example, filter media as described herein that may be disposed within a filtration volume as described herein can include, without limitation: carbon; ion exchange resin; manganese dioxide media; zeolite; silicon dioxide; anthracite; polyester or polypropylene filters; and the like.

It may be appreciated that a filter media or a combination of filter media disposed within a pipe segment as described herein may be selected to target a particular contaminant and/or subset of contaminants. For example, a filter media selected to remove nitrates and nitrites may be different from a filter media selected to remove chromium which may be different in turn from a filter media selected to remove organic material. As such, for embodiments described herein, a given pipe segment may be provided with and/or may have disposed within it, a “filter media” which may be selected for a particular water filtration or contaminant removal process.

Further, for embodiments described herein, a ceramic filter (or, in other cases, another rigid filter media) can be removably coupled to the outlet of the pipe segment. In many embodiments, the ceramic filter may have a disk shape and/or a shape that contours to an inner sidewall of the pipe segment. For example, in many embodiments, the ceramic filter may be a cylindrical disk defined at least in part by a thickness and a diameter. The diameter of the ceramic filter may be less or approximately equal to the ID of the pipe segment so that the ceramic filter may be removably affixed to the outlet portion of the pipe segment. These physical properties of a given ceramic filter, along with a porosity (and/or other material or structural properties) thereof, may define one or more operational characteristics of the ceramic filter, such as the minimum particle size arrestable by the ceramic filter and/or head pressure loss attributable to inclusion of the ceramic filter.

In many embodiments, the physical properties of the ceramic filter are selected at least in part on the filter media type selected for a particular pipe segment. For example, a ceramic filter selected for a pipe segment including filter media for removing nitrates or nitrites may be thicker or may have a different porosity than a ceramic filter selected for a pipe segment including filter media for removing chromium or biological material. In many embodiments, properties of a given ceramic filter may be selected to supplement and assist the filter media associated therewith. As a result, the combined operation of the ceramic filter and the filter media can exhibit similar performance to a much larger conventional filter tank, with a deeper filter media depth over a conventional underdrain.

In view of the foregoing, it may be appreciated that embodiments described herein relate to seamless and multi-stage water filter modules. The seamless structure of the reaction volume significantly reduces failure points and manufacturing complexity associated with conventional welded reaction tanks. Further, multi-stage filtering (e.g., a first stage filter defined by filter media and a second stage filter defined by a selected ceramic filter disk) ensures equivalent performance to substantially larger systems, while requiring less filter media.

Further still to the foregoing, embodiments described herein relate to configurations of filter systems and methods for performing maintenance on such systems. The systems and methods described herein can be used to filter particles, dissolved solids, or other matter from groundwater, surface water, or other water sources.

Broadly, systems described herein leverage pressure and flow rate at an output header of a filter array to serve as the high-pressure clean water input of a backwash process of a single filter of an array of filters. As a result of these constructions, mechanical complexity of water treatment systems is dramatically simplified, cost is reduced, and physical space requirements are reduced, thereby permitting installation of water treatment systems at a greater number of sites.

Specifically, each filter of an array of multiple filters can include two multi-position valves (e.g., three position valves), one at an input port (a port configured to receive water to be filtered when the respective filter is in service) of each filter and one at an output port (a port configured to provide water output when the respective filter is in service) of each filter. In service, each filter's respective multi-position valve pair can be positioned to define a forward flow direction through that respective filter. Operating in parallel, the output flow rate is the sum of the flow rates through each respective filter in service. For example, if four filters are in service and each filters water at 100 gallons per minute, combining the output of each filter results in a flow rate of 400 gallons per minute. A person of skill in the art will appreciate that diameters of pipelines conveying water to, from, and through filters may result in pressure changes, but the flow rate remains constant.

In this configuration, if an input port multi-position valve of one filter is repositioned to decouple the filter from source, flow rate through each of the remaining in-service filters increases proportionately. If the same input port multi-position valve is opened to atmospheric pressure, however, a pressure gradient exists to induce a reversed flow within the filter because the head pressure at the combined output of the in-service filters is greater than atmospheric pressure. In this manner, the input multi-position valve of each respective filter can—by its position alone, and without any external pressurizing source—selectively reverse flow within that respective filter, presuming at least one other filter remains in a forward flow configuration.

As may be appreciated, backward flow as described above, effectively backwashes the filter at higher flow rate than the filters' filtering flow rate. In this manner, the input multi-position valve's position itself defines two modes of the filter: a filtering mode with forward flow; and a backwashing mode with backward flow.

Further embodiments described herein include a second multi-position valve at the output of each filter. This valve can decouple a filter in backwash mode from the output pipeline, effectively stopping flow within the filter. Thereafter the input multi-position valve can be returned to the filtering mode position to encourage forward flow within the filter. In this configuration, however, output of the filter is directed to a reject stream for a period of time. In this manner, the output multi-position valve of each respective filter can—by its position alone, and without any external pressurizing source—selectively connect output of the filter to an output header or to a reject header.

As may be appreciated, forward flow with rejected output as described above, effectively forward-washes a filter at the filtering flow rate. In this manner, the output multi-position valve's position itself defines two modes of the filter: a filtering mode with forward flow; and a forward washing mode with forward flow.

These embodiments, including two multi-position valves for each filter, effectively allow for automatic backwashing and forward flushing of filters in a filter array, while reducing valve counts (and actuators) by half over conventional system, and eliminate requirements for high power pumps or separate water sources dedicated to backwashing.

More generally and broadly, embodiments described herein relate to a filter system that may be integrated in a water treatment system that reduces the start-up costs of the filter system and improves the operation of the system during maintenance. Broadly, the filter system includes multi-position valves arranged in pairs along a respective filter branch. As noted above, each filter branch can include a multi-position valve upstream of a filter, one or more filters (e.g., a volume suitable for retaining a quantity of water and a quantity of filter media(s)), and a multi-position valve downstream of the filter. As described herein, upstream and downstream are used to refer to a position of hardware with respect to a filter operating under normal operating conditions. Generally, each filter system may include an array of filters and/or an array of filter branches, witch the system including at least two filter branches.

The upstream multi-position valve may be positioned at a first node of the branch. At the node, the upstream multi-position valve is fluidly coupled to an inlet pipeline that conveys water from a source, a waste header, and a filter (e.g., via a pipeline or other connecting hardware). The upstream multi-position valve includes at least a first configuration and a second configuration. The first configuration, also referred to as a filtering configuration, filtering mode, or a first mode, couples the flow from the source to the filter and blocks flow to the waste header. The second configuration, also referred to as a maintenance configuration or a second mode, couples the flow from the filter to the water header and blocks flow from the source.

The downstream multi-position valve may be positioned at a second node of the branch. At this node, the downstream multi-position valve is fluidly coupled to the filter, the waste header, and a finished water pipeline that conveys filtered water to a finished water header. The downstream multi-position valve includes at least a third configuration and a fourth configuration. The third configuration, also referred to as an filtering configuration or a third mode, couples the flow from the filter to the finished water header and blocks flow to the waste header. The fourth configuration, also referred to as a maintenance configuration or a fourth mode, couples the flow from the filter to the waste header and blocks flow from the finished water header. It should be noted that the terms first, second, third, and fourth are used to differentiate different modes of different two different multi-position valves and do not indicate an order of operations nor number of configurations available for each of the multi-position valves.

For each branch, the filter is between the upstream and the downstream multi-position valve. The filter may be a post-reaction filter that separates particulate matter from a source or water supply. The filter is configured to output filtered water that can be provided for utility water or other industrial applications. The filter generally includes filter media that separates this particulate matter and which fills only a fraction of the container.

In some cases, each filter branch operates in parallel with respect to the other filter branches. In this manner, a filter branch may be isolated, shut down, or under maintenance while the other filter branches continue to operate. Due to this configuration, each filter branch may be serviced without completely stopping and/or without major impacts to the production of filtered water (depending on the number of filters and the capacity of each of the filters).

Due to the configuration described above, a filter may undergo maintenance using a reduced number of valve operations (compared to traditional systems, which require at least two) and using a pumpless operation. For example, to backwash the filter, a single valve operation of the upstream multi-position valve is used to change the valve from the first configuration to the second configuration. This allows the flow of filter to reverse by using the head pressure from the filtered water output from adjacent filters-and thereby not requiring a pump to reverse flow.

Once backwashing is complete (e.g., once a first time period of filtered water flowing up the filter and to the waste header has elapsed), the branch can be set up for a filter to waste operation. To set up for this operation, the upstream valve is actuated to the first configuration and the downstream valve is actuated to the second configuration. In this set up, source water flows from the inlet pipe, through the filter, and to the waste header to settle the filter media following the backwash. Again, while traditional systems would require at least four separate valve operations, the described system reduces the valve operations to two. By reducing the number valves and valve operations, human error is less likely at least because the operation of the system is simplified. As above, due to the configuration of the valves at the respective first and second nodes, no pump is used to filter to waste. More simply, both filtration and automated backwashing can be “powered” by head pressure of the water source itself.

For simplicity, the system described herein presume a groundwater source, but this may not be required of all embodiments. In non-groundwater embodiments, an input pump may be required to establish appropriate pressure and/or flow rates.

In view of the foregoing, it may be appreciated that generally and broadly a water filtration system as described herein includes a number of multi-stage filters each including a filter body formed from a section of cylindrical pipe oriented vertically. An inlet of each pipe section can be defined at an upper region of the filter body, and a discharge opening can be defined at a lower region. A ceramic filter can be removably mounted near or within the lower region, and a bed of filter media can be disposed above the ceramic filter.

For some embodiments, a flange can be attached near the lower region of the filter body, with an O-ring or gasket placed around a perimeter of a ceramic filter, to retain the ceramic filter against the pipe section. An outlet below the ceramic membrane can route filtered water to another header, a distribution manifold, another filter set (configured for filtering another contaminant), or other conduit. A valve or valve assembly can be coupled at an inlet of the filter body to admit incoming flow or direct backwash flow as required.

The ceramic filter can have a pore size selected according to a target contaminant profile, and/or based at least in part on the filter media bed. For some embodiments, microfiltration or ultrafiltration filter can be mounted, each pore size chosen for particulate, colloid, or dissolved contaminant separation. The filter media above the ceramic membrane can be selected for adsorptive or reactive properties. In some embodiments, manganese dioxide filter media can be used. In other embodiments, different media can be loaded to differing bed depth in an application-specific manner.

At the inlet and outlet of the pipe section, a multi-position valve can be disposed. A first operational configuration of both valves can route influent water from a water source through the filter body to an outlet water header or port. This operational configuration may be referred to as an “in-service” valve configuration.

A second operational configuration of both valves can direct reverse flow through the filter, backwashing the filter media and the ceramic filter, and directing backwash to a backwash outlet (e.g., an effluent outlet). This operational configuration may be referred to as a “backwash” valve configuration.

A third operational configuration of both valves can forward-wash water through the filter, rejecting the output of the filter to the backwash outlet for a period of time. This operational configuration can be referred to as a “forward wash” valve configuration.

A fourth operational configuration of both valves can decouple the filter from the system entirely, permitting chemical cleaning and/or oxidative cleaning of the filter media and/or the ceramic filter. This operational configuration can be referred to as an “out-of-service” valve configuration or “chemical cleaning” valve configuration.

Automatic valve actuation of each multi-position valve of each filter of each filter set can be triggered on a schedule and/or based on one or more differential pressure sensors. Frequent or periodic backwashing of an individual filter body can be performed in parallel systems without stopping flow to other filter bodies.

It may be appreciated that the compound effect of the improvements described herein results in significantly more performant water filtration systems. Furthermore, as a result of the improved filtration of multi-stage systems as described herein, filtration volumes can be reduced, thereby permitting installation of more individual filters the same floor footprint. Furthermore, because filter volumes as described herein can take a smaller cross-sectional area (as compared to conventional welded tanks), packing efficiency of multiple filters within a filter group can be improved.

With a greater number of individual filters per unit of install site space, system uptime may be significantly improved. Further, with improved space efficiency, more individual contaminants can be removed with additional filter groups. For example, a first group of filters may be configured to remove nitrates and nitrites, a second group of filters may be configured to remove or reduce hexavalent chromium or trivalent chromium, a third group of filters may be configured to remove heavy metals, and the like. In these examples, each individual filter group can self-backwash and self-forward wash to maintain filtration capacity.

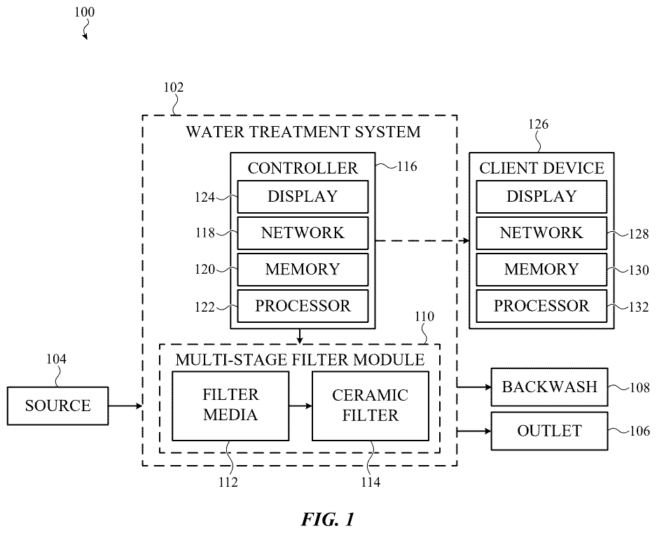

These foregoing and other embodiments are discussed below with reference to FIGS. 1-11. However, those skilled in the art will readily appreciate that the detailed description given herein with respect to these figures is for explanation only and should not be construed as limiting.

FIG. 1 depicts a simplified schematic 100 of a water treatment system 102, which may be configured for self-pressurized maintenance operations. Pipelines, equipment, enclosures, and the like are omitted for clarity.

Broadly, the water treatment system 102 is configured to receive influent water from a source 104. In some cases, the source may be groundwater or surface water. In other embodiments, the source may be a tank or other reservoir that conveys influent water at an inlet head pressure. In some examples, a pump or other equipment may be used to provide the head pressure and/or flowrate needed at the inlet of the water treatment system 102.

The water treatment system 102 may include reactors, filters, and other equipment that treat the input water and produces filtered water. The filtered water is output via an outlet 106. The outlet 106 may refer to pipelines, tanks, containers, or the like which can be configurable to receive the filtered water. In some examples, particularly during maintenance operations, the water treatment system 102 may produce backwash 108.

The backwash 108 may be recycled back to the inlet and/or safely disposed using industry standard procedures. Generally, water output to the backwash 108 may contain particulates and/or other contaminants which do not meet the same standards for filtered water that is output by the outlet 106. In some examples, the backwash 108 may be stored temporarily in a settling tank, to be reintroduced over time into the source 104.

As with many embodiments describe herein, the water treatment system 102 may include a filter array including two or more multi-stage filter modules, one of which is depicted as the multi-stage filter module 110. The filter array can include a manifold or other pluming architecture to distribute influent water from the source 104 to one or more multi-stage filter modules, such as the multi-stage filter module 110. Similarly, each multi-stage filter can be coupled to a manifold or distributor and is plumbed to the outlet 106 and to the backwash 108. The multi-stage filter module 110 defines a filter volume into which is disposed a filter media 112. The filter volume may be capped, at least in part, by a ceramic filter 114. As a result of this construction. water filtering through the filter media 112 flows to the ceramic filter 114.

In some cases, other intermediate steps may be performed prior to the water reaching the ceramic filter 114.

The ceramic filter 114 may include two or more layers of ceramic material which are configured to remove solids, contaminants, colloids, precipitates, and the like, from the water having passed through the filter media 112.

The multi-stage filter module 110 may be coupled to the outlet 106 and/or to the backwash 108. The output line (e.g., the outlet 106 or the backwash 108) may depend on which mode the multi-stage filter module 110 is operating. For example, during normal operations, filtered water may be output at the outlet 106. In maintenance operations, the flowrate of filtered water at the outlet 106 may decrease and the backwash 108 may be actively receiving effluent water from the multi-stage filter module 110.

In some cases, the filter array may be controlled by a controller 116. The controller 116 may be communicatively coupled (e.g., via a network connection 118) to one ore more actuators, manifolds, injectors, and the like. In some cases, the controller 116 may include a memory 120 and a processor 122.

The memory 120 and the processor 122 can be configured to instantiate an instance of a control software that causes actuators, manifolds, injectors, or the like to actuate and/or otherwise change an operation parameter. For the multi-stage filter module 110, the controller 116 can be configured (e.g., via the network 118 or another conductive or wireless coupling) to actuate multi-position valves to predetermined positioned and at predetermined times to perform periodic maintenance of the multi-stage filter module 110. In some cases, maintenance may be performed following a command (e.g., from a technician), in response to a condition (e.g., a sensor indicating maintenance of the filters is due, such as a scheduled event or a differential pressure signal), or the like. In some embodiments, the controller 116 may include a display 124 to display information in respect of an operational mode of the multi-stage filter module 110, the controller 116, or another component or system status.

In some examples, the controller 116 is also communicatively coupled to a client device 126 via a network connection 128. The client device 126 may be a laptop, desktop, tablet, phone, or the like having a processor 130, a memory 132, and a display 134. The client device 126 can be configured to operate the hardware from the water treatment system 102 via the controller 116.

More specifically, the client device 126 can be configured to instantiate an instance of a client application (e.g., using a processor 130 and a memory 132) to access data from the controller, which may include operational parameters, sensor readings, status, control settings, or the like. The client application can be configured to render a graphical user interface via a display 134 of the client device 126. In some cases, the client device 126 is on-site with respect to the water treatment system 102. In some cases, the client device 126 may be remote to the installation site (e.g., communicating via Wi-Fi, one or more cellular networks, or the like).

These foregoing embodiments depicted in FIG. 1 and the various alternatives thereof and variations thereto are presented, generally, for purposes of explanation, and to facilitate an understanding of various configurations and constructions of a filtration system, such as described herein. However, it will be apparent to one skilled in the art that some of the specific details presented herein may not be required in order to practice a particular described embodiment, or an equivalent thereof.

In this manner, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, as noted above, a system as described herein can include a filter set with a number of individual filters, each configured to filter nitrates and/or nitrites from influent water. In this configuration, a nitrate-filtration process can begin when nitrate-bearing influent enters a pipeline segment coupled to a chemical-feed module. A first electronically-controlled metering pump can inject an electron donor at a dose rate based on sensor input, system configuration, or operator input.

In this example, a pipeline segment having a defined internal volume can convey the dosed influent toward a post-filter array. Within the pipeline, nitrates can undergo biological conversion to nitrogen gas by denitrifying within the pipeline segment. Downstream from the pipeline segment, an inlet header or manifold can distribute partially denitrified influent to the filter array, which may be plumbed in parallel.

As with previous embodiments, each filter body can be formed from a unibody, monolithic, or otherwise seamless, weldless, or low weld pipe section into which may be disposed a bed of denitrification media or particle arresting and/or adsorptive media (e.g., manganese dioxide) having a selected granularity and bed depth. After passing through the filter media bed, water can pass through a ceramic disk mounted at a lower region of each filter body; the ceramic disk can have a porosity configured to and/or selected to arrest suspended solids, colloids, precipitates, that escape the denitrification filter media.

In some examples, a differential-pressure sensor pair can monitor head loss between an inlet node above each filter and an outlet node below each respective ceramic disk. When head loss reaches a threshold, the controller 116 can issue or coordinate a command sequence that repositions one or more three-way valves of a respective filter with high head pressure loss to a backwash configuration, thereby reversing flow within the selected filter to backwash that filter.

In other configurations, a filter set as described herein can be coupled to and/or configured for chromium reduction from hexavalent to trivalent and/or arresting or adsorbing of trivalent chromium. For example, a chromium filtration process can begin when chromium-bearing influent enters a reduction reaction pipeline coupled to an electronically-controlled reducer (e.g., ferrous chloride) dosing pump. The dosing pump can inject a reducing agent into the influent at a dosing rate calculated from a chromium concentration value received from a sensor (e.g., an inline ultraviolet spectrophotometer) disposed upstream within a sample port.

The reducing agent can reduce hexavalent chromium to trivalent chromium at a determinable rate. A downstream oxidation injector can introduce an oxidizer (e.g., chlorine) into the reduced influent at another selected dosing rate.

An oxidation pipeline segment can transit the reducing-agent dosed water toward a filter array, such as described herein, permitting iron oxidation and coprecipitation of trivalent chromium.

As with other embodiments described herein, an inlet header or other manifold can distribute precipitate-bearing influent to multiple filter bodies, each of which may be configured as described above from a weldless or low-weld section of pipe. Each filter body can contain a selected depth of filter media, such as manganese dioxide, disposed above a ceramic disk. Precipitated particles can be arrested by the ceramic disk.

In these example embodiments ceramic disk properties selected for a nitrate removal post filtering process may be different than ceramic disk properties selected for a chromium removal process. For example, in some cases, a ceramic disk associated with a nitrate removal process may have a smaller nominal pore diameter than a ceramic disk associated with a chromium removal process. In some embodiments, to ensure consistent head loss, a nitrate removal ceramic disk may have a thickness that is less than a thickness of a chromium removal ceramic disk. In some example embodiments, ceramic filters for different filtering applications can have the same diameter, but may have different thicknesses and/or different porosities. As a result of consistent diameter, filter arrays and/or individual filter bodies can be manufactured consistently regardless of an eventual application. More simply, some embodiments described herein relate to filter arrays formed from piping sections of consistent diameter. Each of the piping sections may be placed in service to filter different contaminants, and may In this manner be fitted with differently specified ceramic filters and/or filter media beds.

Further, as a result of the uniformity of filter body design as describe herein, it may be appreciated that certain filter arrays can be reconfigured on site to filter different contaminants. In these examples, filter media may be changed and/or a ceramic filter associated therewith may be changed from time to time.

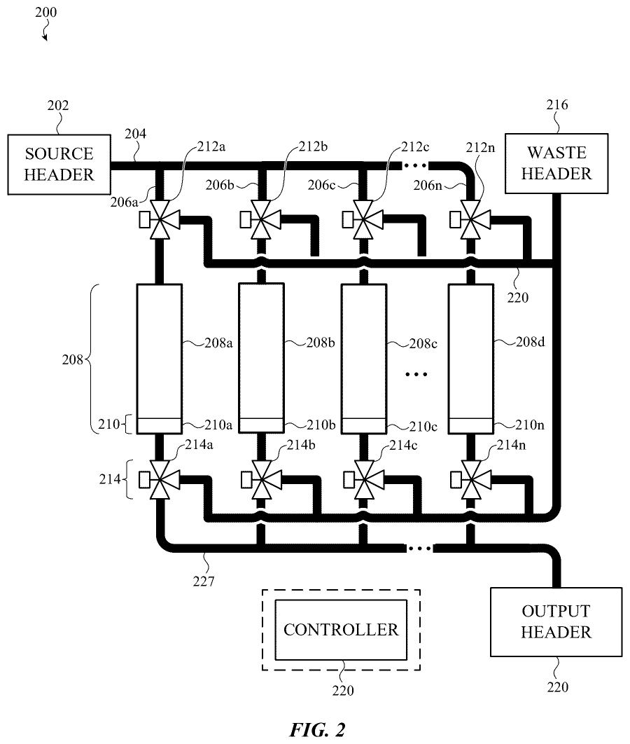

FIG. 2 depicts a simplified process flow diagram of a filter set 200, each filter including a unibody, weldless, seamless, or otherwise low-weld pipe-section based filter body capped with a selected ceramic filter (in place of an underdrain) as described herein.

As with other embodiments described herein, the filter set 200 leverages multi-position valves that redirect the flow along different headers, depending on the maintenance stage.

The filter set 200 first receives input water from a source header 202. The source header 202 may be a well-water source or partially-treated groundwater (water which has been past a reactor or other water treatment hardware) at intermediate stages of the treatment process, as an example. In other cases, the source header 202 may be a surface water source fed from a pump. The source header 202 may convey input water at an initial head pressure and initial flowrate via an input pipeline 204. The input pipeline 204, in turn, may include multiple branches (labeled as the branches 206a-n, or collectively the branches 206) which convey the input water to each of a set of distinct filter bodies, identified collectively as the filter bodies 208 and individual as the filter bodies 208a-n.

Each of the filter bodies 208 may be formed from a section of pipe, such as a metal pipe or a plastic pipe. In some cases, the filter bodies may have identical dimensions (e.g., diameter, height, ID, and OD). In other cases, different filter bodies of a filter array may have different diameters or heights. As noted above, although in many embodiments, a circular cross section may be selected, this is not required of all embodiments. In some cases, rectangular cross sections may be selected for packing efficiency.

In many embodiments, each filter body is vertically oriented such that influent is received at an upper portion of the respective filter body and output water is provided through a lower portion of the filter body. In other cases, a non-vertical angle can be selected-for example, in some installations, a forty-five degree installation angle may be used. In these examples, a tilted filter media bed may provide greater or different filtration than a vertical filtration bed. Many configurations and constructions are possible.

As with other embodiments described herein, each of the filter bodies 208 can be capped on an upper portion with an input node, input header, input valve or other plumbing apparatus configured to couple an interior volume (e.g., filter volume) of each respective filter body to the input pipeline 204.

Similarly, as with other embodiments described herein, each of the filter bodies 208 can be capped on a lower portion with an output node, output header, output valve or other plumbing apparatus configured to couple the interior volume (e.g., filter volume) of each respective filter body to output plumbing. In these examples, the lower portion of the filter bodies can have disposed therein a corresponding ceramic filter, labeled collectively as the ceramic filters 210 and individually as the ceramic filters 210a-n.

In many cases, the ceramic filters may be dimensioned similarly or identically such that each filter body of the filter array exhibits similar head pressure loss and performance. This uniformity can improve the reliability and predictability of backwash operations as described herein. The ceramic filters can have any suitable porosity, thickness, and/or diameter.

In some embodiments, each of the filter bodies 208a-n have a capacity less than the initial flowrate and a working pressure less than the initial head pressure. For example, each pipeline and equipment at each branch may have a smaller diameter than the input pipeline 204. In some cases, each branch may be isolated from the system for servicing without impacting (or minimally impacting) an amount of filtered water output.

In some cases, each branch may have the same equipment configuration. For example, branch 206a may direct influent through an upstream muti-position valve 212a and a downstream multi-position valve 214a coupled to the filter body 208a. As depicted, the upstream multi-position valve 214a influent from source header 202 to the filter body 208a. The upstream multi-position valve 214a can also be configured to couple the branch 206a to a backwash header 216 via a pipeline 218. Other branches may likewise include corresponding multi-position valves, such as the upstream multi-position valves 212b-n and the downstream multi-position valves 214b-n.

As noted above, each multi-position valve may have different actuation positions (referred to herein as “configurations”) that redirect the flow to different branches and which isolate different headers or branches. For example, a first configuration of the upstream multi-position valve 214a directs the flow from pipeline 204 to the filter body 208a and prevents flow to or from the pipeline 218. The first configuration may also be referred to as an “in-service” mode, a filtering configuration.

In a second configuration of the upstream multi-position valve 214a, flow is directed from the filter body 208a to the pipeline 218 and to the waste header 216, blocking flow to/from the pipeline 204. The second configuration may be referred to as a “backwash mode” or a maintenance mode or maintenance configuration.

In an in-service mode, filtered water exiting the filter body 208a having passed through filter media disposed within the filter body and having passed through the ceramic filter 210a, may flow into the downstream multi-position valve 214a. Similar to the upstream valve, the downstream multi-position valve 214a may have multiple configurations and it is operable to redirect the flow from the filter body 208a, according to an operating mode of the system 200. In a first configuration, the downstream multi-position valve 214a directs filtered water from the filter body 208a to an output header 220 via the pipeline 222. In another configuration, the downstream multi-position valve 214a directs water from the filter body 208a to the waste header 216 via the pipeline 224.

More generally, the upstream multi-position valves 212a-n and the downstream multi-position valves 214a-n may be three (or more) position valves that may be operable or configurable in multiple valve configurations. Each of the valves may be configured to be actuated via a mounted actuator that is powered and/or controlled via a controller 226. The controller 226 may be communicatively coupled (either conductively and/or wirelessly) to each respective valve actuator. In some cases, valves may be manually operated. Each valve may be formed from a material rated for the operating condition (e.g., input water with contaminants, backwash, filtered water) of the system 200.

As described herein, multi-position valves are used to describe valves which are coupled to more than one branch and/or header. For example, multi-position valves may be three-way valves. More specifically, multi-position valves may be an L-type three-way valves or T-type three-way valves. In any configuration, a valve as described herein can be operable in multiple configurations: the first configuration in the in-service mode; the second configuration in the backwash mode; a third configuration in a forward wash mode; and a closed configuration for full offline servicing (e.g., chemical cleaning of one or more ceramic filters).

These foregoing embodiments depicted in FIG. 2 and the various alternatives thereof and variations thereto are presented, generally, for purposes of explanation, and to facilitate an understanding of various configurations and constructions of a filtering architecture, such as described herein. However, it will be apparent to one skilled in the art that some of the specific details presented herein may not be required in order to practice a particular described embodiment, or an equivalent thereof.

In this manner, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

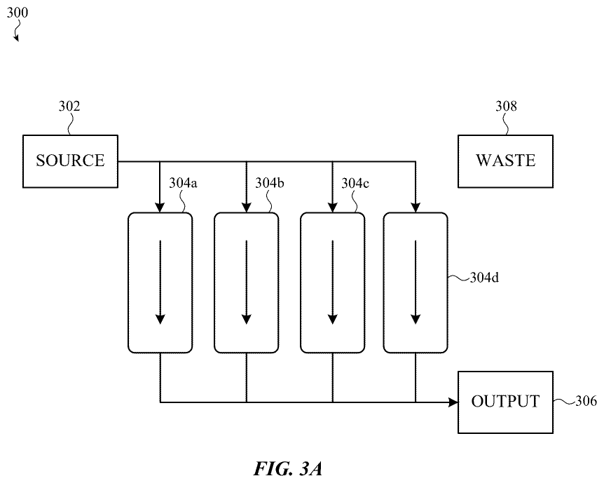

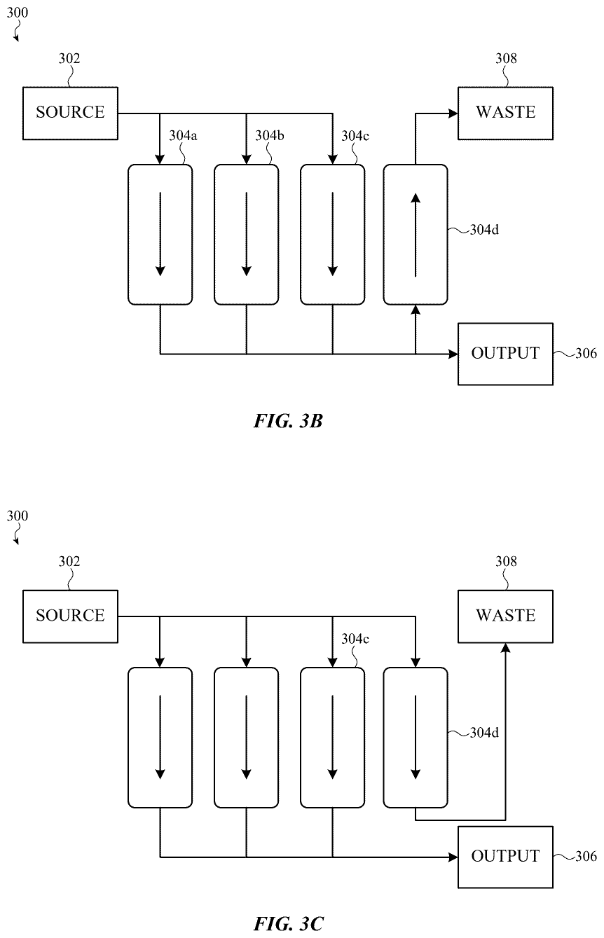

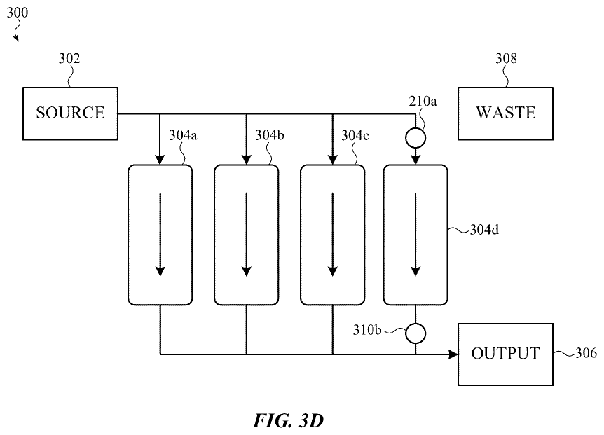

FIGS. 3A-3D depict a simplified flow schematic showing the steps of a backwash procedure of a filter set or a filter array, as described herein. Hardware, including valves and plumbing to couple portions of the system to one another, are omitted from these schematics for clarity. The operation is shown for a system having four filters. However, this operation may be scalable up to any number of filters or down to as few as two filters; many array configurations are possible.

FIG. 3A depicts a flow diagram corresponding to in-service configuration of multi-position valves of four filter bodies of a filter set as described herein. In this schematic, input water from a source 302 flows to each filter body of a set of filter bodies defining the filter set. Individual filter bodies are labeled as the filter bodies 304a-d. Filtered water output from each respective filter body flows to a finished water header 306. In this configuration, a waste header 308 is disconnected from the system; all influent is filtered through the filter bodies.

FIG. 3B depicts a flow diagram corresponding to a backwash configuration of multi-position valves of four filter bodies of a filter set as described herein. In this configuration, the flow from the source 302 to the filter body 304d is blocked, instead diverting an upper portion of the filter body 304d to the waste header 308. In addition, in this configuration, a second multi-position valve associated with the filter body 304d directs water filtered by the filter bodies 304a-304c at least partially through the filter body 304d. In this configuration, flow from the source 302 is directed through three filter bodies instead of four filter bodies as in the in-service configuration, thereby increasing flow rate through these filters by roughly thirty three percent (e.g., transition for each filter from filtering 25% of influent to 33% of influent).

In some examples, the filter body 304d and the waste header branch 308 may be at a first pressure P1 and the finished water header may be at a pressure P2. In some cases, P1 may be greater than P2. In this manner, the pressure and/or flowrate of filtered water output from filters 304a-c can backwash the filter body 304d without additional equipment, such as pumps. In this manner, as noted with respect to other embodiments described herein, a portion of the filtered water flows to backwash the filter body 304d. In some cases, the amount of filtered water that flows up for backwashing the filter may depend on a target backwash flow rate specific to the filter, which may be controlled at least in part by one or more multi-position valves associated with the filter body itself. In these cases, a choke or other flow-control device may be used to adjust the rate of water entering the filter body 304d. Nondiverted filtered water flows to the finished water header 306.

FIG. 3C depicts a flow diagram corresponding to a forward wash configuration of multi-position valves of four filter bodies of a filter set as described herein. In this configuration, the flow from the source 302 is directed through the filter body 304d, but outflow of the filter body 304d is directed to the waste header 308. The filter body 304d can be returned to service, such as shown in FIG. 3D, and may be monitored for a period of time via two or more pressure sensors 310a,310b. Differential pressure information post-backwashing and post-forward washing can be used to determine whether a ceramic filter of the filter body 304d may require chemical restoration/oxidative cleaning.

These foregoing embodiments depicted in FIGS. 3A-3D and the various alternatives thereof and variations thereto are presented, generally, for purposes of explanation, and to facilitate an understanding of various operational configurations of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

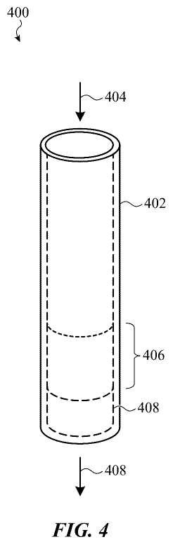

FIG. 4 depicts an example monolithic and/or seamless multi-stage filter as described herein. The multi-stage filter 400 includes a filter body 402 that may be manufactured from a pipe section (which may be schedule rated or manufactured on site). The pipe section defining the filter body 402 may be formed from carbon steel, stainless steel, or polymer-lined carbon steel, PVC, ABS, or other materials or combinations of materials.

The filter body 402 can be defined by an inner nominal diameter, an outer nominal diameter and a length. The length and the inner diameter can define an internal volume, a filtration volume, associated with the filter body 402. Within the filtration volume may be disposed a filter media 406 (disposed to a selected media depth), and a ceramic filter 408 as described herein.

A first axial end (an upper end, when oriented in a vertical orientation) of the pipe section may terminate in a machined shoulder or flange configured to bear against an inlet header and defining an input port 404. A second axial end of the pipe section may define an output port 410 that may be configured to retain and/or support the ceramic filter 408.

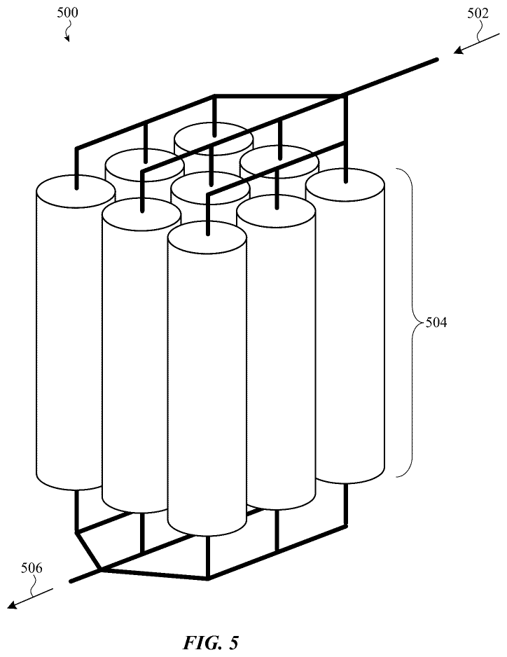

As a result of this construction, a set of filter bodies can be tightly packed together, to provide high filtration volume in a space-efficient package. FIG. 5 depicts an example array 500 of monolithic multi-stage filters as described herein. In particular, in this example embodiment, a set of nine filter bodies can be coupled in parallel to receive influent water from a source 502. More specifically, influent water from the source 502 can be distributed to each of a set of filters 504. The set of filters can cooperate to filter the water received from the source. Each of the set of filters can be backwashed and/or forward washed and/or chemically restored on a schedule or in response to satisfaction of one or more differential pressure sensors outputs. For example, if differential pressure exceeds a first threshold for a particular filter body, that filter body may be backwashed or may be scheduled for backwashing. In another example, if differential pressure exceeds another threshold, that filter body may be scheduled for offline processing, such as by oxidative cleaning. Output of the filter bodies can be combined and provided as output filtered water 506.

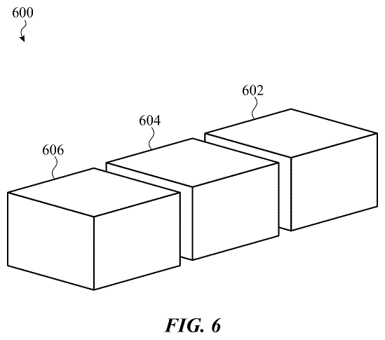

In this manner, a single site can include multiple filter arrays in series, each of which is configured to filter a different contaminant from a water supply. For example, FIG. 6 depicts an example water processing system 600 including multiple arrays of monolithic multi-stage filters. For example, a first filter array 602 (which may include an arbitrarily large number of individual filter bodies, such as shown and described in respect of FIG. 5) may be configured to filter influent of heavy metals, a second filter array 604 may be configured to filter nitrates from the output of the first filter array 602 and a third filter array 606 may be configured to filter chromium from the output of the second filter array 604. In this manner, a set of filter arrays can be coupled in sequence to filter an arbitrarily large number of contaminants from water.

In these examples, ceramic filters associated with each filter body of each filter array or set can have similar dimensions and/or may be interchangeable.

These foregoing embodiments depicted in FIGS. 4-5 and the various alternatives thereof and variations thereto are presented, generally, for purposes of explanation, and to facilitate an understanding of various operational configurations of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

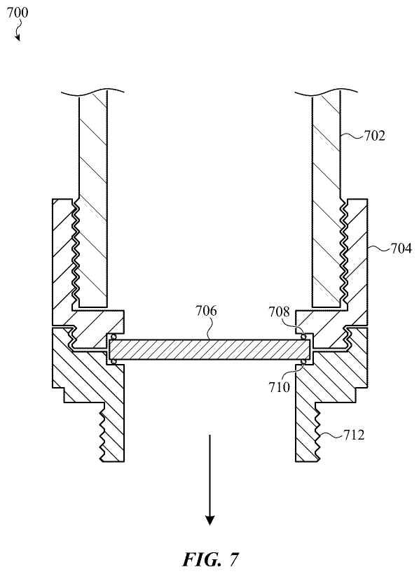

For example, it may be appreciated that a ceramic filter can be coupled to a lower portion of a filter body (e.g., a pipe section) in a number of suitable ways. For example, FIG. 7 illustrates a cross-sectional view of a lower region of a multi-stage filter 700. A filter body 702 defines a vertically oriented cylindrical sidewall having an internal threaded segment configured to engage with corresponding threads of an endcap 704. The endcap 704 a radially-inward annular shoulder that presents an axial sealing surface concentric with a longitudinal axis of the filter body 702. A ceramic filter 706 may be seated against the sealing surface so as to span a significant portion of the internal diameter of the filter body 702.

In many constructions, the ceramic filter 706 may be supported at least in part by opposing elastomeric seals 708,710. In some embodiments, the elastomeric seals may be received at least in part in grooves on opposite faces of the ceramic filter 408 (ad/or the endcap 706 or a retaining flange 712) are compressed axially between the sealing land and an upstream face of the retaining flange 712. The retaining flange 712 can be configured with external threads complementary to an internal threaded segment of downstream plumbing, valves, or other.

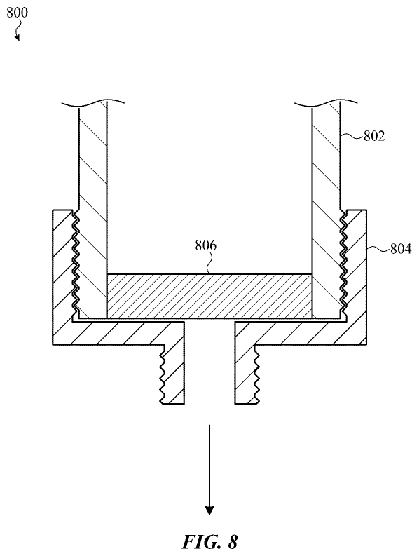

In another embodiment, a ceramic filter may be retained in position by head pressure and gravity. FIG. 8 depicts another cross-section of a filter-retaining endcap of a multi-stage filter as described herein. In this example, a multi-stage filter 800 includes and defines a filter body sidewall 802 with threads configured to engage with corresponding threads of a retaining flange 804 defining a shoulder surface to retain and support a ceramic filter 806.

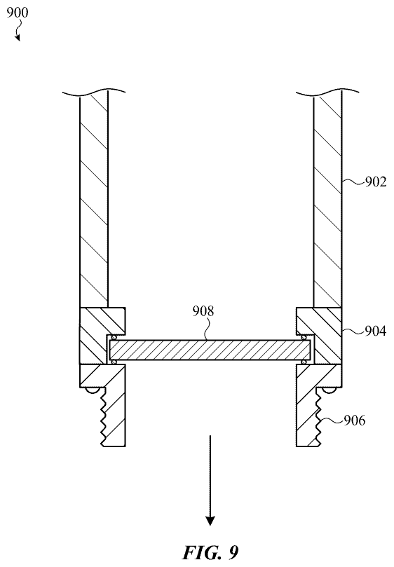

FIG. 9 depicts another cross-section of a filter-retaining endcap of a multi-stage filter 900 as described herein. As with other embodiments described herein, the multi-stage filter 900 includes a filter body 902 defining a cylindrical sidewall oriented along a longitudinal axis. The sidewall can be configured to bear against a retaining shoulder 904 that bolts or otherwise affixes to an output flange 906. The retaining shoulder 904 and the output flange define a ring or groove into which a ceramic filter 908 may be disposed, and supported by elastomeric rings.

These foregoing embodiments depicted in FIGS. 7-9 and the various alternatives thereof and variations thereto are presented, generally, for purposes of explanation, and to facilitate an understanding of various configurations and constructions of a filter body with a ceramic filter, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

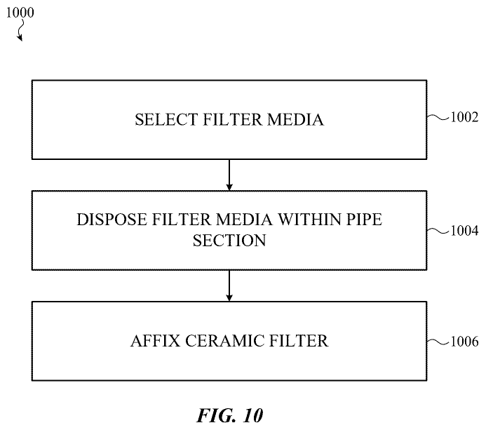

FIG. 10 is a flowchart depicting example operations of a method of operating a multi-stage filter as described herein. The method 1000 includes operation 1002 at which a filter media is selected for a particular filter body. The filter media is selected at least in part based on a target contaminant in a water supply. Next at operation 1004, the filter media selected at operation 1002 may be despised within a pipe section defining the filter body. As noted above, the pipe section may be a unibody, monolithic, seamless pipe section or a low-weld pipe section. Finally, at operation 1006, a ceramic filter selected at least in part based on the filter media may be affixed to a lower axial end of the filter body. In this manner, a multi-stage filter can be formed.

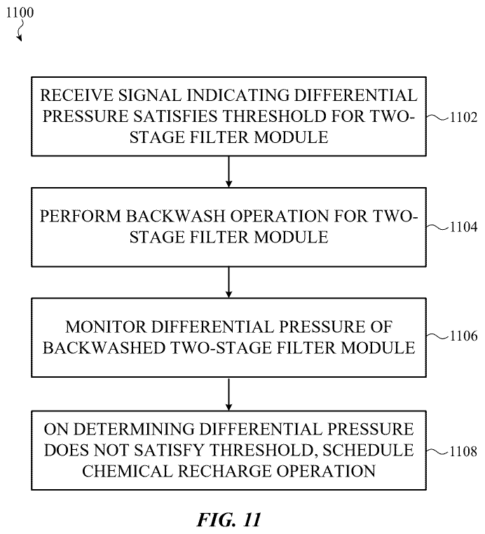

FIG. 11 is a flowchart depicting example operations of a method of maintaining a multi-stage filter as described herein. The method 1100 includes operation 1102 at which a signal is received indicating that differential pressure in respect of an input and an output of a filter body of a filter array or filter set satisfies a backwash filtering threshold. Next at operation 1104, a backwash operation may be performed in respect of the multi-stage filter indicated at operation 1102. Next, at operation 1006, and after the backwash operation has completed, differential pressure may be continually monitored to determine whether the backwash process improved performance of the filter to an expected or target degree. Upon determining that the differential pressure does not satisfy such a threshold, a chemical recharge and/or oxidative cleaning operation can be scheduled at operation 1108.

These foregoing embodiments depicted in FIGS. 10-11 and the various alternatives thereof and variations thereto are presented, generally, for purposes of explanation, and to facilitate an understanding of various operations of methods such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate operation order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. In this manner, the breadth and scope of the present invention should not be limited by any of the above-described exemplary embodiments but is instead defined by the claims herein presented.

1. A water filtration module comprising:
a vertically oriented pipe segment defined by a longitudinal axis and a continuous inner diameter along the longitudinal axis;
an inlet positioned at an upper portion of the pipe segment and an outlet positioned at a lower portion of the pipe segment, the inlet and the outlet separated by the continuous inner diameter of the vertically oriented pipe segment;
a filter media disposed within the pipe segment, at least partially engaging an interior sidewall of the vertically oriented pipe segment, and positioned between the inlet and the outlet and configured to arrest at least one water contaminant from water received at the inlet flowing along the longitudinal axis of the vertically oriented pipe segment toward the outlet; and
a ceramic filter comprising a disk shape defined by a diameter approximately equivalent to or larger than the continuous inner diameter of the pipe segment, wherein the ceramic filter is removably affixed to the outlet of the pipe segment such that the ceramic filter retains the filter media within the pipe segment, the ceramic filter defined at least in part by a thickness, the diameter, and a porosity each selected based at least in part on the at least one water contaminant.

2. The water filtration module of claim 1, wherein the pipe segment is monolithic.

3. The water filtration module of claim 1, where the pipe segment is a low-weld pipe segment.

4. The water filtration module of claim 1, wherein the ceramic filter is retained by a retaining structure coupled to the outlet, the retaining structure comprising:
an annular shoulder; and
one or more elastomeric seals positioned between the ceramic filter and the pipe segment.

5. (canceled)

6. The water filtration module of claim 1, further comprising:
an upstream multi-position valve coupled to the inlet; and
a downstream multi-position valve coupled to the outlet,
wherein each of the upstream and downstream multi-position valves are configured to selectively control flow through the pipe segment in at least a forward filtration mode and a backwash mode.

7. The water filtration module of claim 6, wherein:
the upstream multi-position valve is configured, in the backwash mode, to couple the inlet to a waste header; and
the downstream multi-position valve is configured, in the backwash mode, to admit filtered water from at least one other filter module into the pipe segment through the ceramic filter.

8. The water filtration module of claim 7, wherein:
the downstream multi-position valve is further configured, in a forward flush mode, to direct water from the outlet of the pipe segment to the waste header.

9. The water filtration module of claim 6, wherein each of the upstream and downstream multi-position valves is a three-way valve.

10. A water filtration system comprising:
at least two water filtration modules according to claim 6;
a source header fluidly coupled to inlets of the at least two water filtration modules;
an output header fluidly coupled to outlets of the at least two water filtration modules; and
a waste header fluidly coupled to at least one of the inlets or outlets of the plurality of water filtration modules,
wherein each water filtration module is configured to be backwashed by filtered water output from one or more other water filtration modules of the at least two water filtration modules.

11. The water filtration system of claim 10, further comprising:
a controller communicatively coupled to respective actuators of each respective upstream and downstream multi-position valve of each respective water filtration module, the controller configured to actuate a selected pair of multi-position valves to a backwash configuration based on a differential pressure threshold measured across the respective pipe segment.

12. A water treatment system comprising:
a set of filter branches configured to operate in parallel, each filter branch comprising:
a vertically oriented pipe segment defined by a continuous inner diameter and defining a filtration volume, the pipe segment comprising:
an inlet at an upper portion; and
an outlet at a lower portion;
a filter media disposed within the pipe segment between the inlet and the outlet, at least partially engaging an interior surface of the vertically oriented pipe segment, and selected to remove a target contaminant;
a ceramic filter sized with a diameter approximately equal to the continuous inner diameter of the pipe segment, the ceramic filter:
positioned at the outlet so as to retain the filter media within the filtration volume; and
comprising a pore size and thickness selected to remove the target contaminant;
a first multi-position valve coupled to the inlet; and
a second multi-position valve coupled to the outlet;
a source header coupled to each first multi-position valve;
a finished water header coupled to each second multi-position valve; and
a waste header connected to at least one of the first or second multi-position valves; wherein:
the first and second multi-position valves of each filter branch are configurable to:
in a filtration mode, convey source water from the source header through the pipe segment to the finished water header;
in a backwash mode, convey filtered water from at least one other filter branch through the ceramic filter and pipe segment to the waste header; and
in a forward flush mode, convey source water from the source header through the pipe segment to the waste header.

13. The water treatment system of claim 12, wherein each pipe segment is formed from a seamless metal pipe.

14. The water treatment system of claim 12, wherein each ceramic filter has a respective pore size and respective thickness selected based at least in part on a respective type of filter media disposed within the respective pipe segment.

15. The water treatment system of claim 12, wherein each first multi-position valve comprises a configuration that blocks flow from the source header and the pipe segment for chemical cleaning of the filter media and the ceramic filter.

16. The water treatment system of claim 12, further comprising a controller communicatively coupled to a respective actuator of each first multi-position valve and each second multi-position valve, the controller configured to operate a selected filter branch in the backwash mode based on a differential pressure signal.

17. The water treatment system of claim 12, wherein the finished water header supplies filtered water used to backwash a selected filter branch when the selected filter branch is operated in the backwash mode.

18. A water filter comprising:
a housing formed from a vertical pipe section having a continuous cylindrical wall defined by an inner diameter, the housing defining an internal filtration volume;
an inlet formed at a top portion of the housing and configured to receive untreated water;
an outlet formed at a bottom portion of the housing and configured to discharge filtered water;
a bed of filter media disposed within the internal filtration volume and at least partially engaging the continuous cylindrical wall; and
a ceramic filter having a diameter approximately equal to the inner diameter of the housing and disposed at the outlet, the ceramic filter configured to receive water passing through the filter media, the ceramic filter having a porosity and thickness selected based on properties of the filter media.

19. The water filter of claim 18, wherein the ceramic filter is removably coupled to the bottom portion of the housing.

20. The water filter of claim 18, wherein the porosity and thickness are selected at least in part to arrest the filter media.
